(19) United States
(12) Patent Application Publication
(10) Pub. No.: US 2021/0004760 A1
(43) Pub. Date: Jan. 7, 2021

(54) SYSTEMS AND METHODS FOR MANAGING DENSE STAGING OF PICKUP ORDERS

(71) Applicant: Walmart Apollo, LLC, Bentonville, AR (US)

(72) Inventors: Paul E. Durkee, Centerton, AR (US); Jason D. Shaffer, Rogers, AR (US); Tawfeek Abohammdan, Bentonville, AR (US); Stuart W. Clark, Centerton, AR (US)

(21) Appl. No.: 16/918,430

(22) Filed: Jul. 1, 2020

Related U.S. Application Data
(60) Provisional application No. 62/869,450, filed on Jul. 1, 2019.

(51) Int. Cl. G06Q 10/08; G06F 16/23; G06Q 10/06; G06Q 30/00; G06Q 10/10; G06K 7/14; G06K 7/10; G06F 3/12; B41J 3/407; B65G 1/137; B65G 1/04

(52) U.S. Cl. CPC G06Q 10/0836; B65G 2203/042; G06Q 10/0838; G06Q 10/06315; G06Q 10/0832; G06Q 30/0185; G06Q 10/06316; G06Q 10/063114; G06Q 10/0875; G06Q 10/103; G06Q 10/063118; G06Q 10/06312; G06K 7/1413; G06K 7/10366; G06F 3/1296; B41J 3/4075; B65G 1/1378; B65G 1/1371; B65G 1/0492; B65G 2209/02; G06F 16/2379

(57) ABSTRACT

Systems, apparatuses, and methods are provided herein for managing pickup order staging. A method comprises triggering a pick task for the pickup order via the task management device, wherein the pick task comprises staging filled totes in a section of a staging area assigned to the due time of the pickup order and densely stacking totes assigned to different orders together to a set height and triggering a breakdown task at the breakdown start time via the task management device, wherein the breakdown task comprises separating totes in the staging area assigned to the due time of the pickup order onto multiple movable platforms based on the order serial numbers on each tote.

This application claims the benefit of U.S. Provisional Application No. 62/869,450, filed Jul. 1, 2019, which is incorporated herein by reference in its entirety.

### TECHNICAL FIELD

This invention relates generally to automated systems for inventory logistics.

### BACKGROUND

Store pickup orders are orders that are placed by customers ahead and time and picked up at a store location. Conventionally, a personal shopper would go around the store to gather items for a customer order and the gather items are stored together in a designated area awaiting customer pickup.

### BRIEF DESCRIPTION OF THE DRAWINGS

Disclosed herein are embodiments of apparatuses and methods for managing pickup orders. This description includes drawings, wherein:

FIG. 1 comprises a block diagram in accordance with several embodiments;

FIG. 2 comprises a flow diagram in accordance with several embodiments;

FIGS. 3A-C comprises illustrations of a staging area in accordance with several embodiments; and

FIG. 4 comprises another illustration of staging areas in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for managing pickup order staging. In some embodiments, a system for managing pickup order staging comprises an order database storing a plurality of pickup orders, an electronic identifier reader, a task management device, a label printer, and a central management computer communicating with the order database, the electronic identifier reader, the task management device, and the label printer. The central management computer being configured to determine the number of totes to be used for a pickup order based on items in the pickup order, generate, via the label printer, labels for each tote assigned to the pickup order, each label comprising a tote identifier, an order serial number, and a due time, trigger a pick task for the pickup order via the task management device, wherein the pick task comprises staging filled totes in a section of a staging area assigned to the due time of the pickup order and densely stacking totes assigned to different orders together to a set height, detect for the completion of the pick task based on tote identifiers and product identifiers scanned by the electronic identifier reader, determine a breakdown start time for the pickup order, trigger a breakdown task at the breakdown start time via the task management device, wherein the breakdown task comprises separating totes in the staging area assigned to the due time of the pickup order onto multiple movable platforms based on the order serial numbers on each tote, detect for the completion of the breakdown task based on tote identifiers, and update the order database to indicate that the pickup order is ready for pickup upon the completion of the breakdown task.

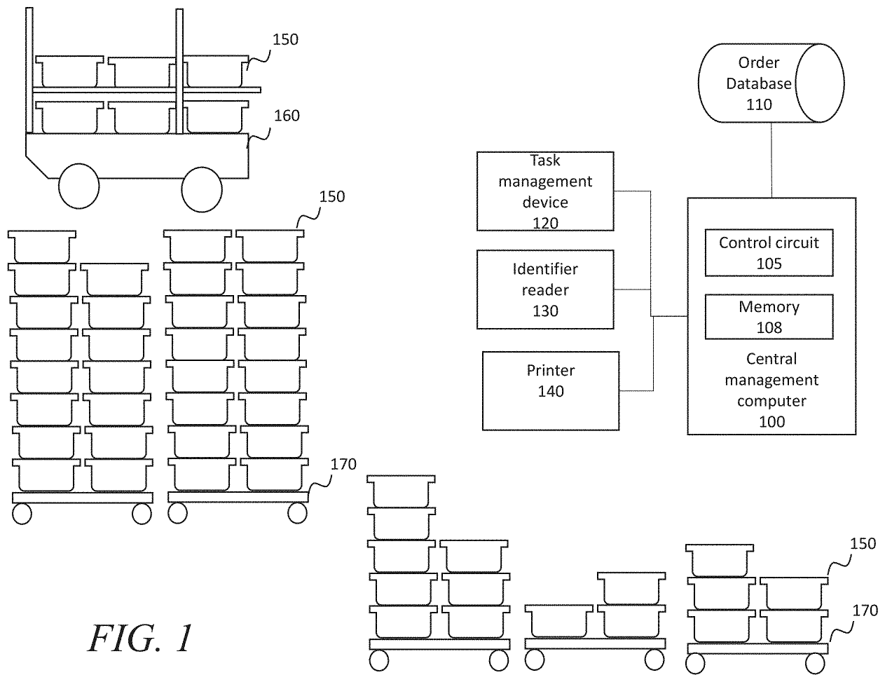

Referring now to FIG. 1, a pickup order management system is shown. The system comprises a central management computer 100 communicating with an order database 110, one or more task management devices 120, one or more identifier reader 130, and one or more printers 140.

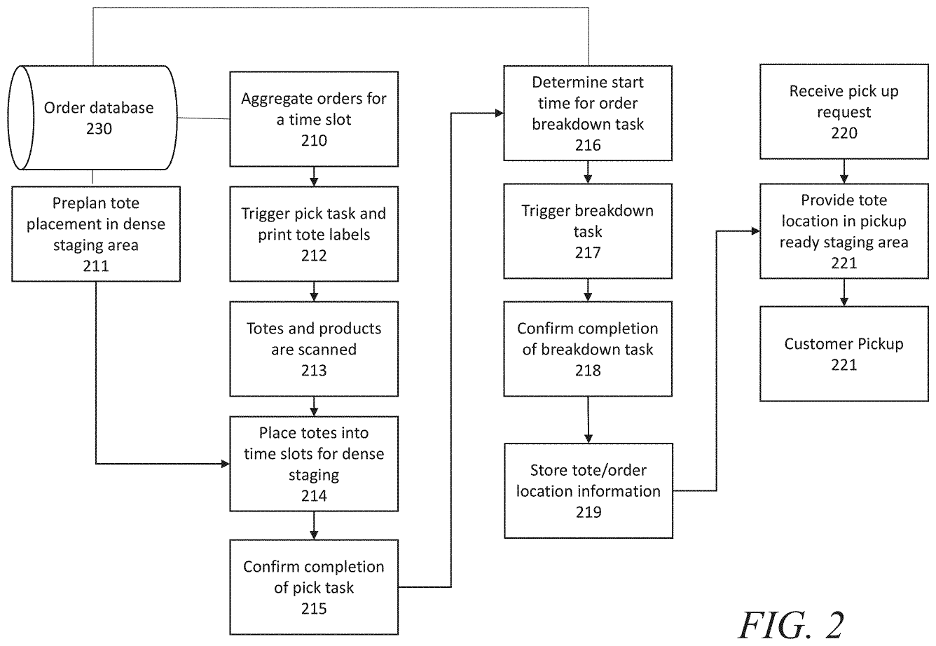

The central management computer 100 may refer to a merchant backend system that manages the fulfillment of pickup orders and/or manages workflow in a retail store. In some embodiments, the central management computer 100 may comprise a processor-based system, a server device, a cloud-based server, a networked computer, etc. In some embodiments, the central management computer 100 may serve a specific store location or comprise an enterprise server system that serves a plurality of geographically dispersed store locations. The central management computer 100 may comprise one or more processor-based devices comprising at least a control circuit 105 and a memory device 108. In some embodiments, the central management computer 100 may further comprise a network adapter configured to communicate with one or more of the order database 110, the task management device 120, the identifier reader 130, and the printer over one or more network such as a private network, a local area network, and the Internet. The control circuit 105 may comprise a processor, a microprocessor, a microcontroller, and the like and is configured to execute computer-readable instructions stored in computer-readable storage memory. The computer-readable storage memory 108 may comprise volatile and/or non-volatile memory and have stored upon it a set of computer readable instructions which, when executed by the control circuit 105, causes the control circuit 105 to coordinate the fulfillment of pickup orders via the task management device 120 and the printer 140 based on data stored in the order database 110 and/or data obtained via the barcode/RFID scanner. In some embodiments, the control circuit 105 of the central management computer 100 may be configured to perform one or more steps described with reference to FIG. 2 herein.

The order database 110 generally refers to a computer readable memory device configured to store pickup orders. In some embodiments, the pickup orders in the order database 110 may each be associated with a due time and include a listing of items in the order. The order due time generally refers to the time that the customer has prearranged to pick up the order. The due time may cover a time frame (e.g. 8:00-9:00 am). In some embodiments, the system may further include a product database storing product information such as storage location, display location, weight, volume, height, width, and length. Information in the product database may be used by the central management computer 100 to generate pick instructions and/or determine how many totes should be assigned to each order.

The task management device 120 may refer to a device for instructing tasks to staff and/or automated machines. In some embodiments, the task management device 120 may comprise handheld/mobile devices that display instructions to workers. In some embodiments, the task management device 120 may comprise a system for executing machine instructions via automated picker machines or sorter apparatuses.

The identifier reader 130 generally refers to an electronic device configured to read/scan an identifier on totes, products, and storage areas. In some embodiments, the identifier reader 130 may comprise a barcode scanner, an RFID reader, a camera, and the like. In some embodiments, the identifier reader 130 may comprise a handheld device. In some embodiments, the identifier reader 130 may be integrated with a task management device 120.

The printer 140 generally refers to a device configured to print text and images. The printer 140 may comprise a label printer configured to print labels for totes used in fulfilling pickup orders.

In some embodiments, the central management computer 100 is configured to instruct and manage tasks for fulfilling pickup orders that are performed using totes 150, pick carts 160, and/or dollies 170. Totes 150 generally refer to reusable containers used to hold products between the time the products are picked for an order and the time that the products are transferred to the customers. Items may be placed in bags and then in a tote 150. In some embodiments, the totes 150 are vertically stackable. When assigned to an order, each tote 150 may be labeled with a tote number and an order serial number (OSN). After an order is picked up, the label may be removed and the tote 150 may be made available for another order or other uses in the store.

The pick carts 160 are wheeled devices configured to be pushed around the store while carrying totes 150 during a pick task. In some embodiments, a pick cart 160 may comprise shelves such that each tote is accessible to the picker without moving another tote. The dollies 170 generally refer to a movable platform configured to carry stacked totes. In some embodiments, a dolly 170 may comprise a handle coupler configured to be coupled to a handle used to push and pull the dolly. Dollies 170 may be used to rearrange totes in a storage area and/or bring orders out to the customer during pickup.

Referring now to FIG. 2, a process for managing pickup orders is shown. In some embodiments, the steps shown in FIG. 2 may be performed by a processor-based device such as one or more of a retailer management system, a retailer backend system, a central computer system, a server, a cloud-based server, etc. In some embodiments, the steps in FIG. 2 may be performed by the central management computer 100 and/or the task management device 120 described with reference to FIG. 1 herein or similar devices.

In step 210, the system aggregates orders for a time slot. For example, orders that are scheduled for pick up at 9 am may be pulled from the order database 230 and processed together. In some embodiments, prior to step 212, the system may first determine how many totes should be assigned to each order. The number of totes assigned to each order may be determined based on the items in each order. In some embodiments, a product database may store product dimension information used by the system to determine the number of totes needed for an order. In step 212, the system generates pick instructions and tote labels. Tote labels may be printed via a label printer for each tote assigned to the order. In some embodiments, each tote label may comprise a tote identifier, an order serial number (OSN), and a due time. In some embodiments, the pick task comprises collecting items in the order from the sales floor and/or the backroom and staging filled totes in a section of a staging area assigned to the due time of the pickup order by densely stacking totes assigned to different orders together to a set height. In some embodiments, the pick task is triggered by sending machine readable instructions to an automated picker machine. In some embodiments, the pick task is triggered by displaying a pick instruction on the task management device, wherein the pick instruction comprises locations of each item in the pickup order. In some embodiments, sections of the staging area are marked with movable time labels such as the sizes of sections assigned to each due time are adjustable. In some embodiments, the system may further generate a task for repositioning the section time labels based on how many total totes are associated with each time slot. For example, if the 8 am time slot include 94 totes, a worker may be instructed to place the time label for 9 am at a position that is 10 rows from the 8 am label.

In step 213, totes and products are scanned as a pick task is performed. For example, a personal shopper may scan each picked product before placing the product into a tote to confirm that the pick is accurate. In step 214, the filled totes are placed into a time slot associated with the order for dense staging. In some embodiments, in a dense staging area, totes are stacked to a set height (e.g. ten totes), with orders assigned to different orders in the same stack. Generally, the totes within the time slot are packed into a few stacks and/or onto as few dollies as possible in dense staging.

In some embodiments, the system may be configured to preplan tote placement in the dense staging area in step 211. The preplanning process may generate dense storage instructions comprising instructions for placing filled totes in specific positions within the section of the staging area assigned to the due time. In some embodiments, the dense storage instruction is determined based on grouping orders with tote numbers that add up to the set height into the same stack. For example, when the set stack height is 10, an order with 3 totes may be stacked with another order for 7 totes, and an order with 11 totes may form one stack and have one tote stacked with another order with 9 totes, etc. Generally, the preplanning process arranges the totes such that totes belonging to the same order as placed in the same stack as much as possible while minimizing the number of stacks in a time slot.

In some embodiments, preplanning may comprise minimizing the number of separate stacks or dollies each order is placed on in the dense staging area based on volumes of each order. For example, the system may instruct an order to be placed on two stacked instead of spreading across five stacks. In some embodiments, the system may analyze the volume of the order (e.g. sum volumes of items in the order) to allocate stacks or dollies to each order. For example, if each dolly has 1000 cubic inches of storage space and order 1 is 700 cubic inches, order 2 is 500 cubic inches, and order 3 is 200 cubic inches in volume, the system may assign orders 1 and 3 to the same dolly and allocate a separate dolly to order 2. In some embodiments, the system may determine the size of all orders in a time slot and determine dense staging positions of each tote based on minimizing the total number of stacks and minimizing the number of stacks in which totes associated with each pickup order is placed. In some embodiments, the system may determine dense staging positions of each tote based minimizing the number of stacks in which totes associated with each pickup order is placed without exceeding the stack capacity of the dense storage area assigned to the time slot.

In step 215, the system confirms the completion of the pick task. In some embodiments, the completion of the pick task is detected based on the scanning of totes and products in step 213. In some embodiments, the completion of the pick task is detected based totes being scanned back into the staging area. In some embodiments, a picker may manually enter the completion of the pick task into the system. In some embodiments, the completion of the pick task may be confirmed based on a signal received from an automated picker machine.

In step 216, the system determines a breakdown start time for an order breakdown task. Generally, the order breakdown time is the time when a worker or a machine is instructed to convert totes in a time slot from dense staging to pickup-ready staging. In some embodiments, the breakdown start time may be a set time before the pickup due time (e.g. 90 minutes prior, 2 hours prior). In some embodiments, the breakdown start time may be dynamically determined based on one or more of time until due time, number of totes associated with the due time, number of orders associated with the due time, storage space availability, and staff availability. For example, the system may estimate the man-hours needed to breakdown orders in a timeslot based on the number of order in the time slot and set the breakdown time according to the number of workers that can be assigned to the breakdown task. In some embodiments, the breakdown time may be determined such that totes are stored in dense staging arrangement for as long as possible while ensuring that the totes have been converted to pickup-ready arrangement by the time customers arrive at the store.

In step 217, the system triggers the breakdown task to begin at the breakdown start time. The breakdown task generally comprises rearranging totes stored in a dense storage arrangement into a pickup ready arrangement. In some embodiments, the breakdown task comprises separating totes in the staging area assigned to the due time of the pickup order onto multiple movable platforms (e.g. dollies) based on the order serial numbers on each tote. In some embodiments, the breakdown task may be performed in the section of the storage area assigned to the time slot and totes are kept in the same area until customers arrive at the store for pickup. In some embodiments, if more space is needed after orders are broken down by OSN, movable time labels marking the time slot sections may be moved to expand the space assigned to the due time into an adjacent section. In some embodiments, totes rearranged to the pickup-ready arrangement may be moved to a separate staging area for customer pickup.

In step 218, the system confirms the completion of a breakdown task for an order. In some embodiments, the completion may be detected when all totes identifiers associated with an order are scanned during a breakdown task. In some embodiments, the completion may be entered by a worker. In some embodiments, the completion may be detected via a signal received from an automated sorting system. In step 219, the system stores the tote and/or order location information. In some embodiments, the location of the tote and/or order may be indicated by a stack or row number. After step 218 and/219, the pickup order may be marked as ready for pickup in the order database 230.

In step 220, the system receives a pickup request. Generally, the pickup request is received from a customer providing a customer ID and/or order number. In some embodiments, the pickup request may be received from an in-store or curb-side customer. In some embodiments, the pickup request may be received over a network from a customer who is on the way to pick up the order. In step 221, the location information stored in step 219 may be provided to a staff member to retrieve the order for the customer. In step 221, the order is conveyed to the customer and the order is marked as fulfilled in the order database 230. At pick up, if the order includes totes in other storage temperatures (e.g. ambient, chilled, frozen), totes may be retrieved from the one or more storage areas and consolidated to convey to the customer at pickup.

In some embodiments, one or more steps shown in FIG. 2 may be optional. For example, steps 211 may be omitted and the totes may be stacked together in the dense staging arrangement without grouping the orders together. In some embodiments, steps 215 and 218 may be omitted and the task may be assumed to be completed a set time after they are assigned. In some embodiments, steps 219 and 221 may be omitted and orders may be sorted by customer number, customer last name, OSN, etc. without tracking the storage location in the system. In some embodiments, each tote may comprise a unique identifier (e.g. RFID) that is associated with an order when the tote is assigned to the order, and the printing of the label may be omitted. For example, with an automated order sorter and/or picker, the automated mechanism may be configured to read the tote unique identifier to retrieve order number and due time without a printed label. In some embodiments, the systems and methods described herein may be used for one or more of ambient, chill, and frozen storage.

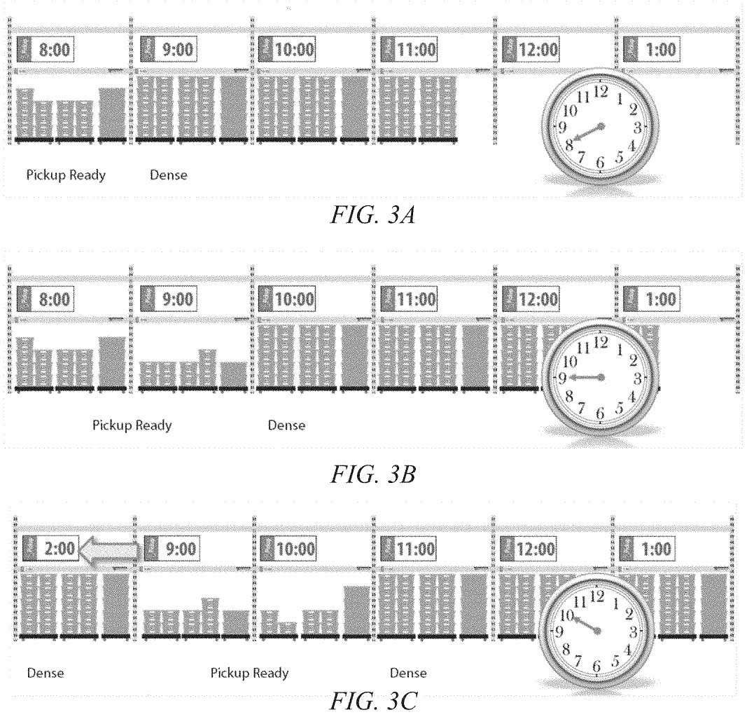

Referring now to FIGS. 3A-C, illustrations of a pickup order storage area is shown. In FIGS. 3A-C, the storage area is divided into 6 sections. FIG. 3A shows that, by 8 am, the orders scheduled to be picked up in the 8 am time slot are stored in a pickup ready arrangement, with each dolly carrying totes belong to a single order. If 8 am is the first time slot of the day, the totes may be initially placed in the pickup ready arrangement without first being in the dense storage arrangement. Totes in 9 am, 10 am, and 11 am slots are stored in the dense storage arrangement. Orders for noon and 1 pm have yet to be picked. In FIG. 3B, by 9 am, the totes in the 9 am slot have been broken down to the pickup arrangement and orders for the noon and 1 pm time slots have been picked. In some embodiments, some space in the 8 am slot may have been freed up, and 9 am time slot space may expand into the 8 am space to accommodate the increase of dolly numbers in the pickup ready arrangement. In FIG. 3C, by 10 am, the totes in the 9 am slot have been broken down to the pickup arrangement and orders for the 2 pm time slots have been picked. The 2 pm totes now occupy the spaced emptied from 8 am pickups. If any orders are not picked up in time, the orders may be moved to a separate area or move into the next time slot's storage space.

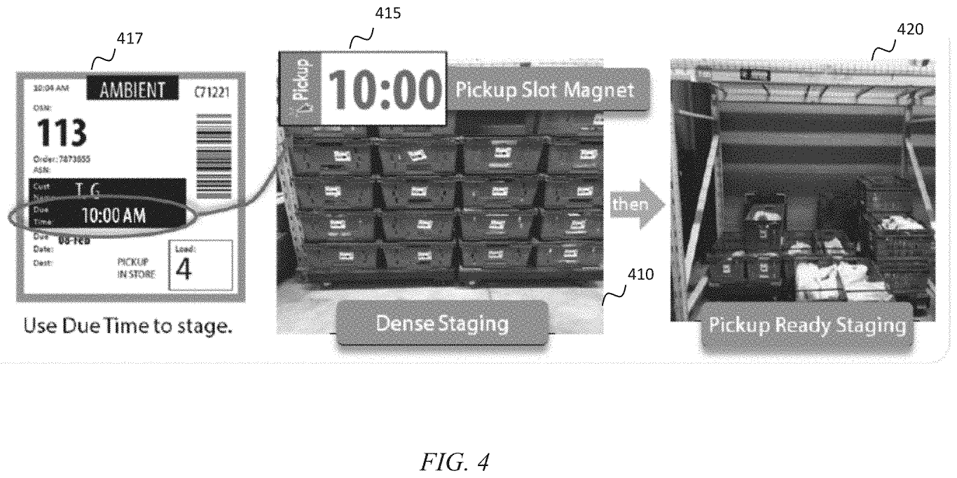

Referring now to FIG. 4, totes in a dense staging arrangement 410 and pickup-ready arrangement 420 are shown. In the dense staging arrangement 410, totes from different orders are stacked together to minimize the number of stacks in the time slot. In the pickup ready arrangement. 420, totes are separated by order such that each stack or dolly contains totes for only one order (e.g. “OSN”). In FIG. 4, each time slot is marked with a pickup slot magnet 415 that shows the due time associated with the storage section. In some embodiments, the magnet label may be moved to adjust the size of each section based on space demand. FIG. 4 also shows an example of a tote label 417. The label includes information such as storage temperature (e.g. ambient), OSN (e.g. “113), guest name (e.g. “T.G.”), due time (e.g. 10:00 am), due date, and a tote identifier (e.g. barcode).

Adding order pickup service to an existing brick and mortar stores requires repurposing other spaces for staging and executing online (including grocery) order pickup. Backrooms of retail stores are typically space-constrained. For grocery orders, portions of orders may be maintained at different temperatures. In a non-space-constrained situation, all totes for a single customer's order could be placed together on one or more dollies right after the orders are picked for pre-distribution storage. The staging area may contain several hours' worth of orders in totes on separate dollies. However, when all totes were staged by order, more dollies and more space are required for storage as not all dollies are stacked to full height (e.g. 10 totes per stack). For example, a dolly could have 10 totes each if stacked to the maximum ergonomically feasible height. Most orders include less than ten totes, therefore space on some dollies is wasted if orders are packed one order per dolly.

In some embodiments, packing orders by timeslot allows for totes in a given order to be separated and packed wherever there is space in the timeslot's area (set of dollies) to minimize the number of dollies used. The timeslot may be unpacked and rearranged by customer order at a later time. In one example, if orders are to be staged for pickup at least 30 minutes prior to the timeslot to accommodate early arrivals, at least 1.5 hours' worth of orders should be staged (current hour plus half hour ahead). The current hour (or current hour and a half) are sorted by order into totes on a cart or racking, and anything further out is sorted by timeslot. At 9:30 am, for example, totes for the 10:00-11:00 timeslot, which are currently organized and placed together, are retrieved and separated into individual orders. Generally, placing product by timeslot, the same number of orders (e.g. 17 Online Grocery Pickup orders) would take up less space than if they are fully separated by order.

In some embodiments, picked totes are initially staged and densely packed by timeslot. At a time closer to pickup (e.g. 90 minutes prior to timeslot start), totes in that time slot are pulled and rearranged to be staged by order. This way the more space consuming packing arrangement (by order) is only for the immediate need and the rest of the totes, which may be several hours' worth of orders, are stored in a more space-saving arrangement (by timeslot, dense).

Starting the breakdown from timeslot staging to order staging too far out could result in too much space lost. The breakdown start time can be dynamically determined to optimize space based on the tradeoff between maximized packing density and ready-to-go staging by order. In some embodiments, the system may determine how far ahead to break timeslot-staged into order-staged on-the-fly. This determination may be based on consideration of current space availability, customers per timeslot, and/or labor availability. The system may select the start time based on having as many orders staged for pick up as possible without overfilling the staging area.

In some embodiments, using known data on items included in an order, the system may determine how many totes are needed for each order and plan dolly loading to optimize space fill. For example, if a dolly holds ten totes, and customer A's order is 4 totes, and customer B's order is six totes, and they are both scheduled for pickup in the 9-LOAM slot, the system can generate instructions to pick those orders and place them on a dolly together.

In some embodiments, when converting to pickup ready staging, containers within the same order can be consolidated, when necessary, to save space. Generally, only containers that are in the same temperature band are consolidated (e.g. frozen with frozen, chilled with chilled and ambient with ambient.) In some embodiments, items are bagged before being placed in the totes and consolidation are completed by the dispenser. In some embodiments, as a picker performs the pick task, an invalid container alert will appear if two different orders are selected to be combined and systematic quality checks will fail if there are multiple labels on a container.

In some embodiments, dense staging is used to save space and minimize personal shopper transition time. Orders are densely staged first, except for the first time slot of the day (e.g. 8 am), and orders being staged within 1 hour of the order pickup time. In one example, up to 10 containers can be placed on each dolly-stacked in two columns of five. Light bulk items that do not fit in a container may be placed above the containers in the same time slot and heavier bulk items may be staged on a dolly in the correct time slot.

In some embodiments, a system for managing pickup order staging comprises an order database storing a plurality of pickup orders, an electronic identifier reader, a task management device, a label printer, and a central management computer communicating with the order database, the electronic identifier reader, and the task management device. The central management computer being configured to, for each pickup order in the order database: determine the number of totes to be used for the pickup order based on items in the pickup order, generate, via the label printer, labels for each tote assigned to the pickup order, each label comprising a tote identifier, an order serial number, and a due time, trigger a pick task for the pickup order via the task management device, wherein the pick task comprises staging filled totes in a section of a staging area assigned to the due time of the pickup order and densely stacking totes assigned to different orders together to a set height, detect for the completion of the pick task based on tote identifiers and product identifiers scanned by the electronic identifier reader, determine a breakdown start time for the pickup order, trigger a breakdown task at the breakdown start time via the task management device, wherein the breakdown task comprises separating totes in the staging area assigned to the due time of the pickup order onto multiple movable platforms based on the order serial numbers on each tote, detect for the completion of the breakdown task based on tote identifiers, and update the order database to indicate that the pickup order is ready for pickup upon the completion of the breakdown task.

In one embodiment, a method for managing pickup order staging comprises aggregating pickup orders in an order database, determining, with a control circuit, the number of totes to be used for a pickup order in the order database based on items in the pickup order, generating, via a label printer, labels for each tote assigned to the pickup order, each label comprising a tote identifier, an order serial number, and a due time, triggering a pick task for the pickup order via a task management device, wherein the pick task comprises staging filled totes in a section of a staging area assigned to the due time of the pickup order and densely stacking totes assigned to different orders together to a set height, detecting, at the control circuit, for the completion of the pick task based on tote identifiers and product identifiers scanned by an electronic identifier reader, determining, with the control circuit, a breakdown start time for the pickup order, triggering a breakdown task at the breakdown start time via the task management device, wherein the breakdown task comprises separating totes in the staging area assigned to the due time of the pickup order onto multiple movable platforms based on the order serial numbers on each tote, detecting, at the control circuit, for the completion of the breakdown task, and updating the order database to indicate that the pickup order is ready for pickup upon the completion of the breakdown task.

An apparatus for managing pickup order staging comprising: a non-transitory storage medium storing a set of computer readable instructions and a control circuit configured to execute the set of computer readable instructions which causes to the control circuit to: aggregate pickup orders in an order database, determine with a control circuit, the number of totes to be used for a pickup order in the order database based on items in the pickup order, generate, via a label printer, labels for each tote assigned to the pickup order, each label comprising a tote identifier, an order serial number, and a due time, trigger a pick task for the pickup order via a task management device, wherein the pick task comprises staging filled totes in a section of a staging area assigned to the due time of the pickup order and densely stacking totes assigned to different orders together to a set height, detect, at the control circuit, for the completion of the pick task based on tote identifiers and product identifiers scanned by an electronic identifier reader, determine, with the control circuit, a breakdown start time for the pickup order, trigger a breakdown task at the breakdown start time via the task management device, wherein the breakdown task comprises separating totes in the staging area assigned to the due time of the pickup order onto multiple movable platforms based on the order serial numbers on each tote, detect, at the control circuit, for the completion of the breakdown task, and update the order database to indicate that the pickup order is ready for pickup upon the completion of the breakdown task.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for managing pickup order staging, the system comprises:
an order database storing a plurality of pickup orders;
an electronic identifier reader;
a task management device;
a label printer; and
a central management computer communicating with the order database, the electronic identifier reader, the task management device, and the label printer, the central management computer being configured to:
determine the number of totes to be used for a pickup order based on items in the pickup order;
generate, via the label printer, labels for each tote assigned to the pickup order, each label comprising a tote identifier, an order serial number, and a due time;
trigger a pick task for the pickup order via the task management device, wherein the pick task comprises staging filled totes in a section of a staging area assigned to the due time of the pickup order and densely stacking totes assigned to different orders together to a set height;
detect for the completion of the pick task based on tote identifiers and product identifiers scanned by the electronic identifier reader;
determine a breakdown start time for the pickup order;
trigger a breakdown task at the breakdown start time via the task management device, wherein the breakdown task comprises separating totes in the staging area assigned to the due time of the pickup order onto multiple movable platforms based on the order serial numbers on each tote;
detect for the completion of the breakdown task based on tote identifiers; and
update the order database to indicate that the pickup order is ready for pickup upon the completion of the breakdown task.

2. The system of claim 1 wherein the breakdown start time is determined based on one or more of time until due time, number of totes associated with the due time, number of orders associated with the due time, storage space availability, and staff availability.

3. The system of claim 1, wherein the breakdown task is triggered by an alert displayed on the task management device.

4. The system of claim 1, wherein the central management computer is further configured to generate dense storage instruction comprising placing filled totes in specific positions within the section of the staging area assigned to the due time.

5. The system of claim 4, wherein the dense storage instruction is determined based on grouping orders with tote numbers that add up to the set height into the same stack.

6. The system of claim 4, wherein the dense storage instruction is determined based on reducing a number of stacks in which totes associated with a pickup order is placed.

7. The system of claim 1, wherein the pick task is triggered by sending machine readable instructions to an automated picker machine.

8. The system of claim 1, wherein the pick task is triggered by displaying a pick instruction on the task management device, wherein the pick instruction comprises locations of each item in the pickup order.

9. The system of claim 1, wherein the breakdown task is triggered by sending machine-readable instruction to an automated order sorter.

10. The system of claim 1, wherein sections of the staging area are marked with movable time labels such as the sizes of sections assigned to each due time are adjustable.

11. The system of claim 1, wherein the order database is further updated to store the location of each tote or movable platform upon the completion of the breakdown task.

12. A method for managing pickup order staging, the method comprises:
aggregating pickup orders in an order database;
determining, with a control circuit, the number of totes to be used for a pickup order in the order database based on items in the pickup order;
generating, via a label printer, labels for each tote assigned to the pickup order, each label comprising a tote identifier, an order serial number, and a due time;
triggering a pick task for the pickup order via a task management device, wherein the pick task comprises staging filled totes in a section of a staging area assigned to the due time of the pickup order and densely stacking totes assigned to different orders together to a set height;
detecting, at the control circuit, for the completion of the pick task based on tote identifiers and product identifiers scanned by an electronic identifier reader;
determining, with the control circuit, a breakdown start time for the pickup order;
triggering a breakdown task at the breakdown start time via the task management device, wherein the breakdown task comprises separating totes in the staging area assigned to the due time of the pickup order onto multiple movable platforms based on the order serial numbers on each tote;
detecting, at the control circuit, for the completion of the breakdown task; and
updating the order database to indicate that the pickup order is ready for pickup upon the completion of the breakdown task.

13. The method of claim 12 wherein the breakdown start time is determined based on one or more of time until due time, number of totes associated with the due time, number of orders associated with the due time, storage space availability, and staff availability.

14. The method of claim 12, wherein the breakdown task is triggered by an alert displayed on the task management device.

15. The method of claim 12, further comprising:
generating dense storage instruction comprising placing filled totes in specific positions within the section of the staging area assigned to the due time.

16. The method of claim 15, wherein the dense storage instruction is determined based on grouping orders with tote numbers that add up to the set height into the same stack.

17. The system of claim 15, wherein the dense storage instruction is determined based on reducing a number of stacks in which totes associated with a pickup order is placed.

18. The method of claim 12, wherein the pick task is triggered by sending machine readable instructions to an automated picker machine.

19. The method of claim 12, wherein the pick task is triggered by displaying a pick instruction on the task management device, wherein the pick instruction comprises locations of each item in the pickup order.

20. The method of claim 12, wherein the breakdown task is triggered by sending machine-readable instruction to an automated order sorter.

21. The method of claim 12, wherein sections of the staging area are marked with movable time labels such as the sizes of sections assigned to each due time are adjustable.

22. An apparatus for managing pickup order staging, comprising:
a non-transitory storage medium storing a set of computer readable instructions; and
a control circuit configured to execute the set of computer readable instructions which causes to the control circuit to:
aggregate pickup orders in an order database;
determine with a control circuit, the number of totes to be used for a pickup order in the order database based on items in the pickup order;
generate, via a label printer, labels for each tote assigned to the pickup order, each label comprising a tote identifier, an order serial number, and a due time;
trigger a pick task for the pickup order via a task management device, wherein the pick task comprises staging filled totes in a section of a staging area assigned to the due time of the pickup order and densely stacking totes assigned to different orders together to a set height;
detect, at the control circuit, for the completion of the pick task based on tote identifiers and product identifiers scanned by an electronic identifier reader;
determine, with the control circuit, a breakdown start time for the pickup order;
trigger a breakdown task at the breakdown start time via the task management device, wherein the breakdown task comprises separating totes in the staging area assigned to the due time of the pickup order onto multiple movable platforms based on the order serial numbers on each tote;
detect, at the control circuit, for the completion of the breakdown task; and
update the order database to indicate that the pickup order is ready for pickup upon the completion of the breakdown task.
